(19) United States
(12) Patent Application Publication
(10) Pub. No.: US 2013/0204761 A1
(43) Pub. Date: Aug. 8, 2013

(54) E-Power exchange and management service

(71) Applicant: Sidney P. Smith, Savannah, GA (US)

(72) Inventor: Sidney P. Smith, Savannah, GA (US)

(21) Appl. No.: 13/385,641

(22) Filed: Feb. 28, 2012

Related U.S. Application Data
(60) Provisional application No. 61/632,975, filed on Feb. 2, 2012.

(51) Int. Cl. G06Q 30/06

(52) U.S. Cl. 705/37

(57) ABSTRACT

The present invention is a business method software program that resides in the memory of a computer network. The computer network has a server that is in communication with a plurality of client computers. The client computers reside in buildings or structures that are consuming energy. The server facilitates the command and control of the business aspect of green energy and/or electric power, via E-Power Exchange and Management Service Control Center embodied in data structures of the business method invention.

### CROSS-REFERENCE TO RELATED APPLICATION

This patent application claims the benefit of U.S. Provisional Application No. 61/632,975 filed on Feb. 2, 2012 which is included herein as a reference.

### BACKGROUND

Electrical power has become and essential commodity. It is needed to power homes, vehicles, businesses, recreational facilities, parks, Interstate highway lighting, toys, computers, etc. Presently, most of the electrical power is produced by hydroelectric means, nuclear energy, or coal and is distributed to consumers via electrical transmission grids and lines belonging to one or more power companies. Typically, the power companies control the production, management, distribution, and the collection of payment for the service rendered. The consumers, generally, have no controls or choices in the type of power selected, means of distribution or in reference to rate paid. They just have to accept the power transmitted and have to pay the power company or companies for the services. They also have limited avenues for reacting to increases in the cost of the electricity or the services. During the last two decades, the cost of acquiring power has risen continuously each year. Some electrical companies say the increase in electrical service is due to the limited supply of electrical power and the cost to produce the Kilowatts. Others state the increase in cost for service is due to demands from consumers wanting more energy. The latter is true, consumers, are using more energy, but they want more efficient energy that does not pollute the environment and they want a constant flow of power. Even though consumers express their wants, they still have no avenues to choose or select the type of power they wish to use in their homes, businesses, parks, etc. Neither do the consumers have an opportunity to bid for the lowest price.

### SUMMARY

Limitations of the distribution of traditional electrical power continues to grow and become more complicated as time passes and as cities grow. Also the production of electrical power, by means of hydroelectric, nuclear energy and/or coal processing, is approaching limitations and creating problems for humans and the environment. Each of the above processing method has limitations and each has consequences for people and/or the environment. The following statements stipulate some of the limitations and/or problems. They are:
(1) Hydroelectric. In reference to hydro-electric power, it is limited because almost all facilities have to be built on the banks of rivers or lakes or at a dam fed by a strong flow of water. Such limitations lead to problems. Hydroelectric plants tend to pollute the rivers, lakes and dam waters that serve as the source for turning the turbines to generate electrical power and pollute the source of drinking water of the people. As a result, the rivers, lakes and dam waters become unusable by humans, animals, and the aquatic plants, unless the water is cleaned.
(2) Nuclear Energy. Nuclear energy, used to produce electricity, has its own set of limitations and problems. One problem relates to where the plant can be located, because it, too, needs a supply of water to cool the Reactors. Another major problem relates to the impact of “spent nuclear fuel rods.” The “spent nuclear fuel rods,” identified as no longer being able to produce electrical energy, have to be stored in a safe location because they are a toxic hazard to individuals for generations. Normally, the “spent rods” are stored in underground caves or vaults for the life of radioactive materials. The storing process becomes a major cost factor for decades and continues to effect the environment of the stored location.
(3) Coal. Coal used to fuel a plant that generates and distributes electricity also has limitations and problems. One limitation relates to where the plant can be located, because it must have a large retaining area for the coal that has to be stored until used. Such requirement leads to acquiring acres of land just for storing coal. Another problem or limitation is how to transport the coal from the stored location to the plant for processing. The latter limitation creates several problems: (1) What kind of infrastructures will have to be built to receive tons of coal for storage? (2) How can the coal be transported to the plant? (3) What machinery will be needed to transport the coal? (4) Where will the machinery be stored? (5) Who will operate the machinery? (6) Who will manage and supervise the transportation aspects? (7) What will be the cost? Each of the latter increases the cost for generating electrical energy. Even though, coal is plentiful and relatively inexpensive for producing electrical power, researchers and environmentalists state that coal is an unsound producer of electrical energy and it pollutes the atmosphere; thus, causing harm to humans, animals, plants and the environment. Another problem relates to how can companies and users of coal capture the residue of coal ash and safely store it?

Knowing the latter information, has promoted individuals and companies to search for energy sources that are transmissible and renewable, but not harmful to humans or the environment. Currently, there are many emerging technologies such as solar, wind, bio-generation, or geothermal energy sources, to name a few, that are not destructive to the environment and require no storage of “spent resources”—because there are none. The above energy sources are commonly referred to as “green power sources.” Such power sources, although available and effective at meeting electrical power needs, are hampered by the lack of any means to command and control the delivery of produced power to consumers. Currently the only mechanism of delivery is via a power company that acts as an intermediary between itself (the power company) and the consumers.

Analogy.

Electrical power and consumption is similar to a lake. Power producers are like streams that drain into a lake raising the level of the water while at the same time consumers are using water from the lake and are like streams of water flowing from the lake, thus, causing the lake water level to fall. As long as the water entering and exiting the lake are equal, the volume of the lake water never changes, but the entering water is not the same as the exiting water that is being removed from the lake by the consumers.

Basically, the concept of green power is the same as the above analogy. When green power is added to the lake (Kilowatts), it mixes with other existing water (Kilowatts); therefore, the entering power is not the identical power transmitted to or acquired by the consumers. During the power input and output, the amounts of production and/or consumption are monitored, maintained, and controlled. Specifically, the green power/energy stays balanced. For many decades, the power companies have controlled and determined the production of electrical energy and have organized consumption, and distribution of the electrical power. They even govern their own companies under the control of Public Service Commission. In addition, the power companies even capture and transmit the power they produced through their own electric grid system. Today, the only mechanism of delivery is still via the power companies and their lines and grid system. Presently, each power company acts as intermediary between the power company and the consumers who pay for the services.
Today, consumers are becoming more cognizant and interested in protecting the environment and are seeking green energy as their power source, but their choices and avenues for purchasing green energy are limited. E-Power Exchange software offers producers and consumers several choices and avenues for selling and/or purchasing green power. The E-Power Exchange software allows direct sales between any producers and consumers and between E-Power Exchange and the power company and between other producers of green energy and any consumers who wish to purchase green power, while simultaneously interfacing management avenues among all individuals, businesses, universities, government regulatory agencies, etc. It also controls the sales and exchanges between E-Power and the power companies.
As the economy declines, consumers want more ways to improve their buying power. They want more competitive bidding prices via alternative energy sources. E-Power provides consumers with alternatives; such as bidding and competitive pricing. It allows consumers direct access to the costs for power and kinds of power available. It also allows the consumers to contract with specific producers of power. All transactions are via contracts and are monitored and validated via electronic on-line transactions and reports. There is a continuous interfacing link among all producers, consumers, power companies, distributors, government, regulatory agencies and E-Power Exchange and Management Service Control Center.
The business and accounting aspects of power production and consumption of power or green energy are separated from the physical production and consumption of power because each is a separate process. The role of the power company is to maintain the integrity of the transmission system by directing the flow of power and its distribution and, at the same time, keeping a balance on the grid. In addition, the company is responsible for capturing power, storing it, and preventing the flow of power from fluctuating. As a result, the company keeps the power level in balance for transmission.
The accounting of the actual power production and consumption has not reached the same degree of validation, but through many systems and various programs, E-power Exchange Software initiates avenues to meet current existing realities in the business environment. Also at the same time, the software permits the E-Power Exchange & Management Service Control Center to manage, monitor, control, validate purchases, consumptions, payments, and produce reports for all linked parties.
Until recently, the power company was the sole provider of power and sole accountant for contracting, monitoring and billing for power consumption. With the emergence of the green power sources and increased sophistication of consumers, new integration software is being created and implemented to accommodate the changing reality of plurality of power producers, power consumers and government agencies. E-Power software allows for real-time billing and real-time accounting of power production, distribution and consumption among all parties.

When taken in conjunction with the accompanying drawing and the appended claims, the features and advantages of the present invention, becomes apparent that the E-Power Exchange software meets the needs of producers and consumers. It also contributes to a cleaner environment. Also upon reading the following detailed description of embodiments of the invention, each step will clarify the whole.

### BRIEF DESCRIPTION OF THE CHART COMPONENTS

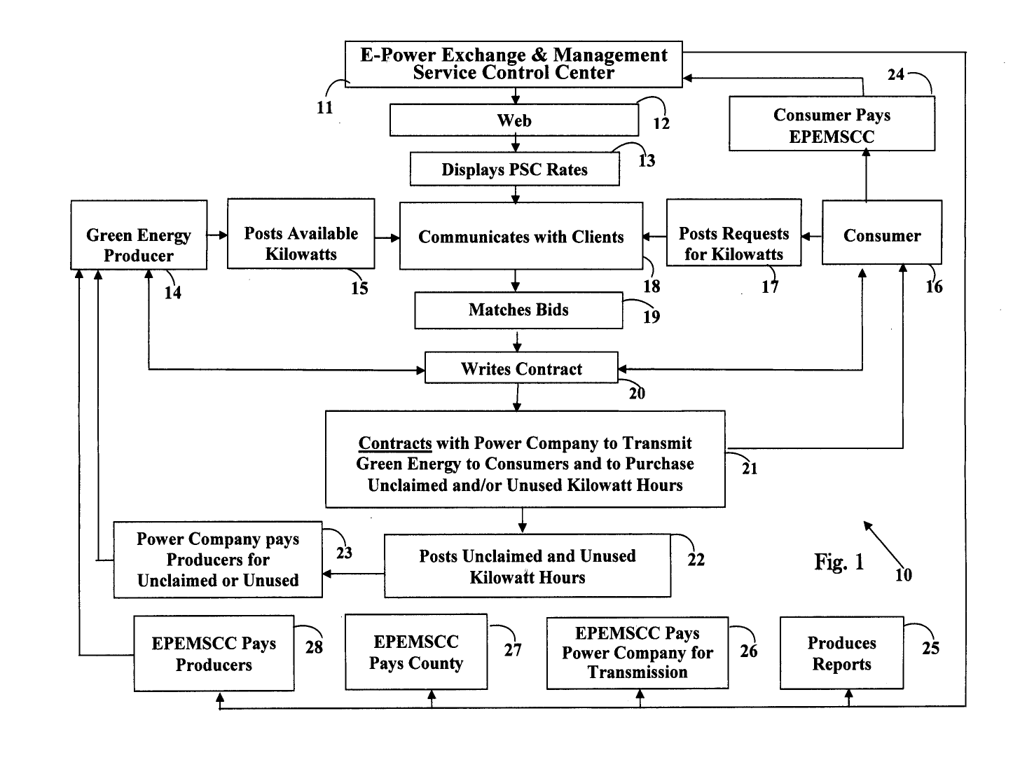

The present invention is illustrated in the Chart Component drawing in which like reference characters designate the same or similar components throughout the software and are shown in FIG. 1 of which:

FIG. 1 Illustrates a top-level block chart view of the present invention.

### DETAILED DESCRIPTION

Before describing in detail the particular system architecture for E-power Exchange and Management interaction, in accordance with the present invention, it should be observed that the invention resides primarily in the novel data structures of the system software and not in the combination of a conventional system apparatus. Examples of some system apparatuses are computers, databases, telephone networks, smart meters, PBX systems, and/or communication systems linking one or more of the system apparatuses to a local area network, wide-area network, or Internet network. The present invention utilizes discrete sub-systems or sub-assembly components, and associated controls to instruct the aforementioned system apparatuses and components. The invention is not in the particular detailed configuration of a system apparatus, but in the command and control modes thereof. Accordingly, the data structures, commands, controls, and arrangements of the present invention, have for the most part, been illustrated in the drawing by a readily understandable block chart diagram. The drawing illustrates only those specific details that are pertinent to the present invention so as not to obscure the disclosure with structural details that are readily apparent to those skilled in the art and having the benefit of the description herein.

The present invention is a business method/model software program 10, FIG. 1 that resides in the memory of a computer network via E-Power Exchange & Management Service Control Center 11, FIG. 1. The computer network has a web server 12, FIG. 1; that is, in communication with a plurality of client computers. The client computers and smart meters reside in the “power consuming” homes, commercial buildings, universities, government buildings, and/or any other structures that consume power via power companies.

The server facilitates the commands, controls and executes each via the action of the E-Power Exchange software, and/or the E-Power Management and Service Control Center. It also handles the distribution of data/information to all client computers and/or government regulatory agencies. The E-Power Exchange is an interface that performs the following functions:
Functions as E-Power Exchange and Management of Services and Control Center (EPEMSCC) via E-Power Exchange software. 11, FIG. 1
Connects Web site with EPEMSCC, 12, FIG. 1
Displays the base rate set by the Public Service Commission 13, FIG. 1
Invites green energy producers to utilize E-Power Exchange services. 14, FIG. 1
Posts on-line available Kilowatts hours from green energy producers 15, FIG. 1
Invites green energy consumers to utilize E-Power Exchange services. 16, FIG. 1
Posts consumers' requests for green energy i.e. solar, micro-hydro, wind, geothermal, etc. 17, FIG. 1
Lists producers and consumers' bids on E-Power Exchange Web bulletin 12, FIG. 1
Communicates with clients 18, FIG. 1
Confirms matched bids with producer or producers with consumer or consumers 19, FIG. 1
Initiates and transmits via on-line contract between producer or producers and consumer or consumers 20, FIG. 1
Contacts and contracts with local power company or companies to distribute green energy (power) to consumer(s) and to purchase unclaimed and/or unused Kilowatt hours 21, FIG. 1
Posts unclaimed and/or unused green energy Kilowatt hours 22, FIG. 1.
Power company pays producer or producers for unclaimed and/or unused Kilowatts 23, FIG. 1
Receives payment from consumer for services rendered 24, FIG. 1
Generates a plurality of reports 25, FIG. 1
Pays power company for transmitting green energy to consumers 26, FIG. 1
Pays County 27, FIG. 1
Pays producer or producers
Pays E-Power Exchange and Management Control Center staff and officials 11, FIG. 1

Although, only a few exemplary embodiments of this invention have been described in detail and outlined above, anyone who is skilled in the art will readily appreciate that modifications are possible in the exemplary embodiments without materially departing from the novel teachings and advantages of this invention. Accordingly, all such modifications are intended to be included within the scope of this invention as defined in the following claims, means-plus-function clause is intended to cover the structures described herein as performing the recited function and not only structural equivalents but also equivalent structures. Although a nail and a screw may not be structural equivalents in that a nail employs a cylindrical surface to secure wooden parts together, a screw employs a helical surface, in the environment of fastening wooden parts, thus, a nail and a screw may be equivalent structures.

I claim:

1. A method of managing the business aspects of producing power by green energy source in exchange for culture and sensitivity or equivalent from consumers, comprising the following steps:
a) providing a Web site hosted by at least one computer in communication with a plurality of search engines;
b) controlling management services in communication with at least one said Web site;
c) displaying Public Service Commission rates;
d) receiving requests from green power producers to list available green power Kilowatts via said management services;
e) posting “available” Kilowatts from producers;
f) receiving requests from consumers for green power Kilowatts via said management services;
g) posting “needed” Kilowatts from consumers;
h) communicating and matching said producers and/or consumers bids for lowest posted green energy power Kilowatt hours;
i) initiating a contract between producer or producers with consumer or consumers;
j) contracting with a local power company to transmit power from the green energy source to consumer;
k) posting unclaimed and/or unused Kilowatts hours for interested parties or power companies;
l) directing power companies to pay producers for unclaimed and unused Kilowatts;
m) establishing at least one cost for handling business data structures via said management services; and
n) selecting at least one of said cost for processing business data structures to deliver reports or payments.

2. A method of managing the business aspects of producing power recited in claim 1 wherein said Web site finds the lowest energy price for the consumer through a bidding process.

3. A method of managing the business aspects of producing power recited in claim 1 wherein said Web site communicates said lowest energy price to the consumer via said management services.

4. A method of producing power recited in claim 1 wherein said reports are selected from a group consisting of reports by producers of green energy of the total Kilowatts sold, reports by consumers of total Kilowatts purchased, and reports by said power company of total Kilowatts distributed.

5. A method of producing power recited in claim 1 wherein payment is selected from a group consisting of payment negotiated via said management for power company to transmit green power, payment made to producers by power company for unclaimed and/unused green energy Kilowatts, payment made to said management by consumers for Kilowatts used, payment made by E-Power Exchange to the county, and payment made to E-Power Exchange and Management Service Control Center for data, reports and services rendered.

6. A method of managing the business aspects of producing power by green energy source in exchange for cash or equivalent from producers, comprising the steps:
a) providing a Web site hosted by at least one computer in communication with a plurality of search engines;
b) controlling a management service in communication with at least one said Web site;
c) listing Public Service Commission rates;
d) receiving a bid for selling green energy power from the producers via said management services;
e) contracting for lowest bid posted by producers in exchange for cash or equivalent;
f) agreeing to post unclaimed Kilowatts to power companies;
g) establishing at least one cost for doing business data structures via said management services; and
h) selecting at least one of said cost of doing business data structures to deliver reports or payments.

7. A method of managing the business aspects of producing power by green energy source in exchange for cash or equivalent from consumers, comprising the steps:
a) providing a Web site hosted by at least one computer in communication with a plurality of search engines;
b) controlling a management service in communication with at least one said Web site;
c) listing Public Service Commission rates;
d) receiving a bid for purchasing green energy power from the consumer via said management services;
e) matching said bid from the consumer in exchange for cash or equivalent;
f) contracting with a local power company to transmit power from the green energy source;
g) establishing at least one cost for doing business data structures via said management services;
h) selecting at least one of said cost of doing business data structures to deliver reports or payment; and
i) accepting said bid for transmission of power to consumer, in return, for payment of services including cost plus a selected profit percentage payable for green energy to said management for services.
